(19) United States
(12) Patent Application Publication
(10) Pub. No.: US 2021/0188145 A1
(43) Pub. Date: Jun. 24, 2021

(54) SAFE VEHICLE TRASH DISPOSAL SYSTEM AND USE THEREOF

(71) Applicant: Johnny Michel KHOURY, Henderson, NV (US)

(72) Inventor: Johnny Michel KHOURY, Henderson, NV (US)

(21) Appl. No.: 17/260,446

(22) PCT Filed: Aug. 2, 2019
(86) PCT No.: PCT/IB2019/056597

§ 371 Date: Jan. 14, 2021

Related U.S. Application Data
(63) Continuation of application No. 16/053,833, filed on Aug. 3, 2018, now abandoned.

(51) Int. Cl. B60N 3/08; B65F 1/14; B65F 1/00

(52) U.S. Cl. CPC B60N 3/08; B65F 1/1415; B60N 2002/905; B65F 1/0026; B65F 1/002

(57) ABSTRACT

The present invention relates to a vehicle trash disposal system used for disposing of vehicle trash quickly, effortlessly and safely. The system consists of an outer permanent bag having a magnetic closing mechanism on the upper part and an inner trash bag that is releasably connected to the outer permanent bag. A combination of magnetic strips, supporting frame, ear tag and optimized design contribute to the quick, effortless and safe use of the system. The proposed use of the system includes a specific mechanism which is crucial for safe usage by a driver even while driving. The system is ergonomic in that it allows for quick and effortless opening and closing especially for the driver, thus ensuring safe and secure disposal of trash and refuse.

The present application is a continuation-in-part from Non-Provisional US patent application U.S. Ser. No. 15/088,415 filed on Apr. 1, 2016.

### BACKGROUND OF THE INVENTION

### Field of the Invention

The present invention relates to a safe vehicle trash disposal system for disposing and storing vehicle trash quickly, effortlessly and safely. While the objective of this invention is meant to be used by all present in a vehicle, the key advances here is safety and particularly as it applies to the driver when using such a system.

### Description of the Related Art

The use of trash disposal systems and devices is well known in the prior art including in moving vehicles. For instance, a number of patents and patent applications disclose various trash collection devices and systems used to provide storage for vehicle trash.

As an example, U.S. Pat. No. 5,362,153 provides a litter bag for automobiles. The problem '153 tries to solve is the inconvenience of use or the large size of then available systems, making them unsuitable for use in the automobile. The solution '153 proposes is a convenient situated strapped system. However, '153 does not tackle the safety of the use of the system by the driver. The invention as disclosed in '153 fails to provide for a quick, effortless and safe access to the system by the driver.

U.S. Pat. No. 8,376,200 discloses a trash collector for vehicles in which trash produced in the vehicles are collected and processed neatly and efficiently. The trash collector includes: a body having a space for containing trash and an opening portion; a fixing clip which is detachably installed on an inner side surface of the body; and a roll of vinyl bags which are hung on the hanging portions of the fixing clip and are successively supplied downwards in the body. Once again, the disclosed invention fails to provide for the use of a system quickly, effortlessly and safely by the driver of the vehicle.

U.S. Pat. No. 5,226,576 discloses a portable waste receptacle with large capacity that closes when full, and which uses recycled bag liners. '576 does not disclose a system which allows a driver to quickly, effortlessly, and above all, safely dispose of vehicle generated trash while driving.

The above cited documents and others cited in reference to those disclose various attempts at finding solutions for size, installation and efficiency of portable trash systems for use in vehicles. None however disclose a safe vehicle trash system which allows a driver to maintain concentration on the road and use said system quickly, effortlessly and safely.

Furthermore, none of the prior art documents disclose the various mechanisms by which these indispensable criteria are met and which required a hefty investment in time and innovation to overcome the hurdles of creating a system which can be used by a driver on the go in a quick, effortless and safe manner.

### SUMMARY OF THE INVENTION

The number of distractions available to drivers, especially since the advent of mobile telephones, has contributed to increasing the number of road incidents. While this here is not a statistical paper on traffic accidents, it is clear from warnings from all traffic management authorities throughout the world that any distraction caused while operating any vehicle, increases the risk of accidents, sometimes fatal ones. In most, if not all countries, it is illegal to have a telephone conversation while driving unless a non-distracting system is installed in the vehicle. It is also considered illegal in many countries to text while driving.

It is also notable that there is a regular increase in the times spent commuting using cars, trucks and other such vehicles. Morning commutes during which rushing drivers grab a bite on the go, or vacationing commuters driving long distances to reach their destinations, all of which generate trash and refuse which is generally disposed of in the vehicle, until at least reaching a final destination where these can be disposed of in a more suitable and permanent manner.

It is often the case when drivers are alone, without any passengers, but no trash disposal systems have been made available for these drivers to be able to quickly, effortlessly and safely dispose of any trash generated during their commute. Be it smelly refuse, contagious paper tissues or other, which should preferably be disposed of in a manner so as not to release pungent smells if left in the vehicle, or risk contaminating the vehicle or potential passengers.

Therefore, it is an object of the present invention to provide a safe vehicle trash disposal system that is adapted to be added-on to the vehicle, simple to operate and customizable to adapt to all vehicle shapes and sizes and does not have to be dismantled to empty the trash. Above all, it is the object of the present invention to provide a quick, effortless and safe means to achieve this to a driver, without adding any distraction to those presently existing ones.

It is another object of the present invention to provide a vehicle trash disposal system that is compact and does not affect the vehicle's interior legroom or space, especially in compact and small cars, without losing the main features of rapid, effortless and safe disposal, especially by a driver. A preferred accessible location for a driver is the back of the front passenger seat. Since this position is generally situated behind and to the side of the driver (right side for left-mounted steering vehicles and left side for right-mounted steering vehicles), it is necessary that the driver be able to dispose of the trash quickly, effortlessly and safely (i.e. without being distracted from the road ahead).

As an aspect of the present invention, there is provided a vehicle trash disposal system that is efficient and seals trash contained therein from the vehicle environment yet allows the driver to dispose of trash quickly, effortlessly and safely, even while driving.

In another aspect of the present invention, there is provided a vehicle trash disposal system that prevents odors of trash contained therein from contaminating the vehicle environment.

As another aspect of the present invention, there is provided a vehicle trash disposal system comprising essentially of an outer permanent bag having magnetic closing strips on the top part and an inner trash bag that is releasably connected to the outer permanent bag. The magnetic strips on the top part of the permanent bag ensure that any trash inside the inner trash bag is kept out of sight and releases minimal, if any, odor as a result of the closing mechanism of the magnetic strips.

As another aspect of the present invention, there is provided a vehicle trash disposal system comprising essentially of an outer permanent bag having magnetic sealing strips on the top part and a plurality of inner trash bags that are releasably connected to the outer permanent bag. Each inner trash bag is intended to receive a specific type of trash so as to aid in recycling efforts once an inner trash bag is emptied. The magnetic strips on the top part of the permanent bag ensure that any trash inside the inner trash bags is kept out of sight and releases minimal, if any, odor as a result of the closing mechanism action of the strips.

As another aspect of the present invention, there is provided a vehicle trash disposal system that is opened by the user by means of a tab attached to the front part of the outer permanent bag and closed by pushing the outer surface so that the magnetic strips tightly close the outer permanent bag. The tab is positioned at the same level of the magnetic strip embedded on the top of the front part of the outer permanent bag for reasons described herein below.

Preferably, said inner trash bag is connected to the outer permanent bag by means of buttons.

Preferably, the outer permanent bag is connected to a car seat by means of adjustable strings, belts or both strings and belts.

### BRIEF DESCRIPTION OF THE DRAWINGS

The invention will be described with reference to the accompanying drawings, which illustrate preferred embodiments of the present invention without restricting the scope of the invention thereof, and in which:

FIG. 1a and FIG. 1b represent a mounted view of a vehicle trash disposal system according to a preferred embodiment of the present invention. Items 13 and 15 in each figure, respectively, represent one embodiment of a frame to be further discussed herein below.

FIG. 2a and FIG. 2b are front views of a vehicle trash disposal system according to preferred embodiments of the present invention.

FIG. 3 is a back view of a vehicle trash disposal system according to a preferred embodiment of the present invention.

FIG. 4a is a cross-sectional view from the inside of the back of a vehicle trash disposal system according to a preferred embodiment of the present invention.

FIG. 4b is a cross-sectional view from the inside of the front of a vehicle trash disposal system according to a preferred embodiment of the present invention.

FIG. 5 is a side view of a vehicle trash disposal system according to a preferred embodiment of the present invention.

FIG. 6 is a cross-sectional view of the side of a vehicle trash disposal system according to a preferred embodiment of the present invention.

### DETAILED DESCRIPTION OF THE INVENTION

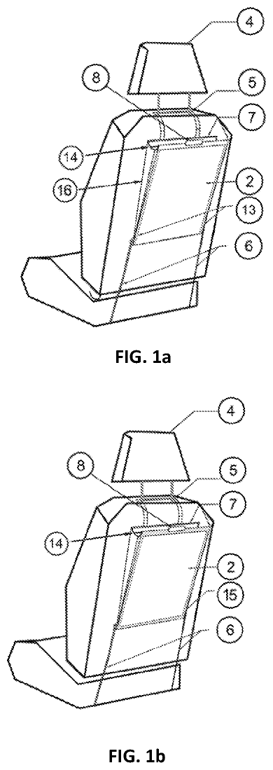

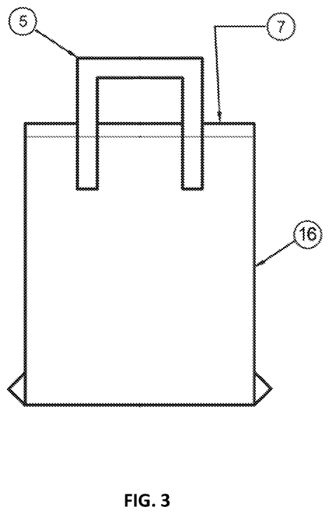

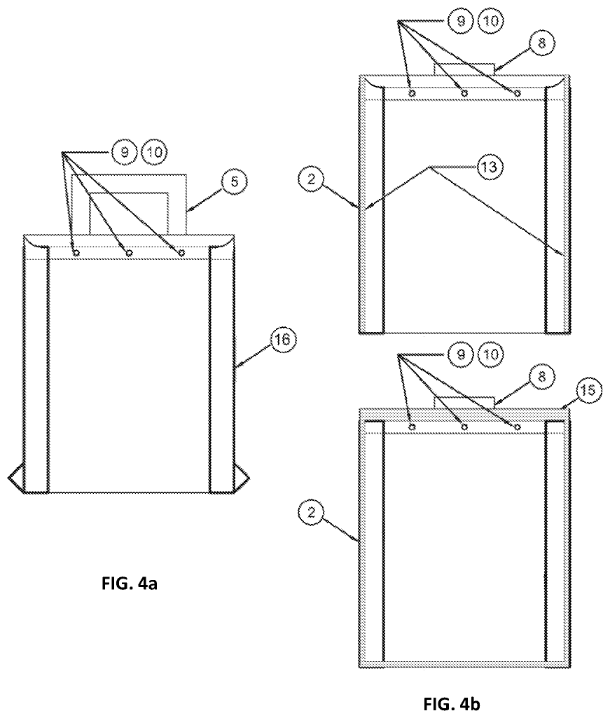

FIGS. 1-6 illustrate a vehicle trash disposal system 1a/1b used for storing trash generated in a vehicle, configured according to a preferred embodiment of the present invention. Whereas the embodiments would apply to a system which may be utilized by any passenger in the vehicle, it is imperative to understand that the preferred embodiments disclosed herein provide for a quick and effortless use of said trash disposal system safely by a driver, without causing any significant distraction.

The key to ensuring a quick, effortless and safe use of the vehicle trash disposal system 1a/1b to a driver is to provide the following features: (1) a vehicle trash disposal system which is firmly and securely placed in its location so that vehicular movement does not cause it to flap or move around; (2) the vehicle trash disposal system can be easily opened every single time with minimum and effortless exertion of a pulling action on the proposed mechanism of the present invention; and (3) the vehicle trash disposal system can just as easily be closed every single time with minimum and effortless exertion of pressure on the proposed mechanism of the present invention. It is the intention of the various embodiments of the present invention to provide for a mechanism for installing and using the vehicle trash disposal system quickly, effortlessly and safely as described through the present application.

Special care and investment in time and effort is given to the front part 2 of the vehicle trash disposal system to ensure that several criteria are met in support of the quick, effortless and safe use of the system. It is worth defining the front part 2 here as the primary moving part of the system whereby when pulled open, the front part 2 will be hanging to allow the system to be in the open position. In order to maintain the front part 2 in a straight and firm position, avoiding it from twisting down or sideways thus making closing the system inconsistent, an embodiment of this invention is to account for a supporting frame to the front part 2.

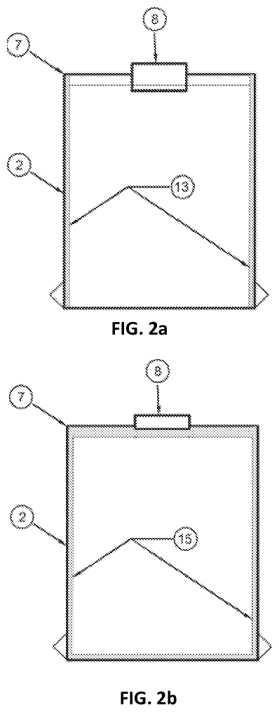

In one embodiment, the supporting frame 13 is provided for with two parallel hard rods or the like extending from the bottom all the way to the top of the front part 2 as depicted in FIG. 2a. In another embodiment, the frame 15 is provided for as a rectangular solid frame which takes the shape of the contour of the front part 2 as depicted in FIG. 2b. In a further embodiment not shown here but which is capable of providing the same function necessary in order to ensure the safe use of the system, the frame 13 or 15 may be U-shaped extending from one side down to the bottom of the front part 2, across the bottom and back up to the top of the opposite side of the front part 2. Alternatively, the U-shaped frame may be extending from one side up to the top of the front part 2, across the top and back down to the bottom of the opposite side of the front part 2. Any combination thereof of the frame which provides for a sturdy and rigid front part 2 when in the open position, while not expressly described or mentioned in the present description is considered as a part of the present invention, and is crucial for providing for a safe use of the system 1.

In a further embodiment relating to the front part 2, is disclosed a tab, latch or ear tag 8 which allows for the quick, effortless and safe opening of the system 1 by a driver without any significant distraction. This tab 8 is instrumental in the overall mechanism of ease and safe use of the system 1. In a further embodiment, said tab 8 is preferably positioned towards the top of the front part 2, an even more preferably, at the same level as the magnetic strip 7 which is embedded on the top part of the front part 2. It is a function of the system that a gentle pull on the tab 8 will release the front part 2 from its secure closed position and bring it into the open position for quick access for disposing of the trash.

In a preferred embodiment of the present invention are disclosed at least two magnetic strips 7 each spanning up to the length of the top of the front part 2 and the top of the back part 16. In this preferred embodiment, it was found that it is necessary to have such strips in order to ensure quick, effortless and safe use of the disclosed system. Just as the frame (13 or 15) disclosed in previous paragraphs has as one of its functions to maintain the front part 2 in the defined position, so do the magnets ensure that when taking the system from the open to the closed position, the tops always align perfectly to ensure a quick and effortless closing mechanism.

It is the object of this invention that the combination of the magnetic strips 7 and the frames 13 or 15 is crucial in order to prevent the top of the front part, where the magnetic strip 7 is housed, from flipping or twisting in an unusual manner. If such were the case, the driver will have to be distracted from his driving in order to properly close the system. Hence the necessity of having the frames 13 or 15 extending to the very top of the front part 2 becomes obvious to a person skilled in the art.

In the present preferred embodiment whereby the magnets are magnetic strips 7, and by magnetic strips it is meant either one long unitary strip or a number of smaller magnets aligned to form a strip, the same provides for a more pleasant experience for the system. Whereas the magnetic strips do not provide for a hermetically sealed environment inside the vehicle trash disposal system, they provide for a tightly closed system thus preventing odors from seeping through and contaminating the inside of the vehicle.

Furthermore, the proposed preferred embodiment for the use of the magnetic strips 7 is to ensure that the system will remain tightly closed even when full. Any smaller surface contact between the magnets 7 will result in a weaker closure and cause the system to open either due to vehicle movement or pressure exerted on the front part as the trash volume increases. It was surprisingly found that even with the magnetic strips 7 as proposed by the preferred embodiment herein, the driver is still able to quickly, effortlessly and safely access the system.

A further embodiment of the present invention which also contributes to the quick, effortless and safe use of the disclosed trash system, relates to the sides 14 of the vehicle trash disposal system and which connect the back part 16 to the front part 2. The sides 14 are instrumental in that they provide additional stability to the front part 2 when the latter is in the open position and for proper closing. When going from the closed to the open position, the sides will unfold to a maximum pre-determined length holding the front part 2 at a pre-determined angle from the back part. This is a further indispensable characteristic of the present invention to ensure quick, effortless and safe use of the system. By limiting the position of the front part 2 to a pre-defined distance and angle when in the open position, the driver will not experience any significant distraction when blindly reaching out to the open from part 2 and pushing it back into the closed position.

It is the contention of the present application that, combined or alone, four of the preferred embodiments thus far disclosed, and not previously disclosed by any prior art, are essential to ensure a quick, effortless and safe use of a vehicle trash disposal system. The frame 13 or 15 disclosed provides for a preferred structure; the magnetic strips 7 combined with the frame 13 or 15 ensure an improved closing mechanism; the sides 14 ensure that the system remains on a specific imaginary track, not allowing for twisting or misalignment of the system as a whole; and the tab which is positioned and attached as described throughout the present description to enhance one of the safety aspects of the mechanism, the effortless use, used for opening the system.

While the embodiments disclosed herein above all aim at providing for an effortless, quick and safe use of the system, it is obvious that depending on materials used or quality of build, one or two of said embodiments will provide for the same effect as if all four characteristics were included in the manufacture of the system. The system as disclosed herein aims at describing various features and characteristics which alone, can provide for a safe vehicle trash disposal system, but combined, provides for a sturdier and more secure and performing system.

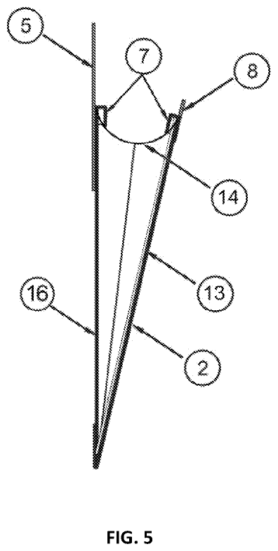

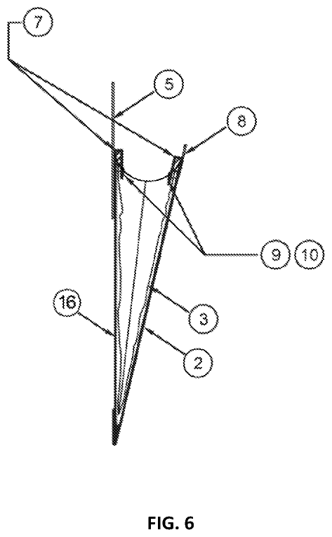

In a preferred embodiment, the sides 14 are disposed of in a manner whereby when the system of the present invention is in an open position, the side view structure of the system is triangular in shape as seen in FIGS. 5 and 6. The purpose of this embodiment, albeit not novel in the art, is to avoid unnecessary loss of space as a result of the use of the disclosed system, while maintaining the essential features of the present application which are quick, effortless and safe use of the system.

In a further preferred embodiment, while the bottom of the sides 14 form the tip of a triangle, the top part is shaped in a downward curve or any other form which has a downward pointing form. It is the contention of the present invention that when in the closed position, any other form on that top part will interfere with the proper tight closing action of the magnetic strips, thus either preventing the actual closing of the system or weakening said closing whereby vehicle movement may prop it loose.

The invention as disclosed in its preferred embodiment relating to the shape of the top of the sides 14 is necessary. There are two manners by which to avoid the folding of material which blocks the proper action of the magnets: (1) limit the top of the sides to below the level where the magnets meet; and (2) the proposed embodiment whereby the top of the sides reach the very top of the system and are shaped downward as described above. It is the contention of the present invention that it is necessary that (2) be used to maintain a quick, effortless and safe use of the system. Alone, this embodiment can also help prevent the portion where the magnetic strip is embedded from twisting in case the proposed frame is not utilized or becomes damaged.

By having the sides 14 extend to the very top of the system, they provide further necessary holding power to the top of the front part 2 where the magnet resides and prevent this top part from twisting downwards due to the weight of the magnetic strip. It is crucial that the sides reach the top as described and shown 5 and 6 to also hold the front part 2, together or independent of the proposed frame 13 or 15, in a consistent manner when in the open position. It is also the contention of the present application that this feature is essential to maintain the magnetic strips in a parallel position when the system is in the open position, thus ensuring a correct closing mechanism, and a total use of the system, i.e. opening, maintaining open and closing, which is quick, effortless and safe.

Although the process of closing the system is not disclosed here, it is clear for a knowledgeable person that any other form will interfere with the proper and adequate closing of the system. Said knowledgeable person can understand that as the sides collapse into the closed position, they will form creases which will stack up on top of each other creating a thicker layer of material between the two magnetic strips 7. Hence it is essential that the top part of the sides be in a shape whereby such folded material is not an issue and will not interfere with the proper action of the magnets. For illustration purposes only, the shape disclosed in the drawings is a downward arc shape, which when folded, will not cause a thick layer of fabric to fold where the magnetic strips 7 will align on the top of the front part 2.

With reference to FIG. 5, the vehicle trash disposal system 1a/1b comprises an outer permanent bag and an inner disposal bag releasably attached to the outer permanent bag. The outer permanent bag is preferably aesthetic, and conforming to the car. The outer permanent bag can be made from any suitable material or color. It could also be a designer bag. The exposed side of the outer permanent bag can also be used to display any picture, image, map or commercial.

In the preferred embodiment, the outer permanent bag is releasably connected to a vehicle seat 4 by means of a top adjustable connection 5 and a bottom adjustable connection 6. The top adjustable connection 5 connects to a top portion of the car seat 4 and the bottom adjustable connection 6 connects to a bottom portion of the car seat 4. The top adjustable connection 5 can either be a string type connection or a belt type connection. Similarly, the bottom adjustable connection 6 can either be a string type connection or a belt type connection. It is a requirement for the present invention that the upper and lower connections, 5 and 6, respectably, be included in order to secure the vehicle trash disposal system 1a/1b in a tightly fixed position which will not move or shift at any moment while the vehicle is moving. It is the intention for this to ensure that the driver can always reach out and locate the vehicle trash disposal system 1a/1b without the need to ever look back or be distracted in locating its position and accessing its mechanism. If the vehicle trash disposal system 1a/1b is only connected on top of a car seat 4 by means of a top adjustable connection 5, then the vehicle trash disposal system 1a/1b will shift and sway in position relative to the movement of the vehicle.

Furthermore, the bottom adjustable connection 6 ensures that the vehicle trash disposal system 1a/1b remains flat against the back of the vehicle seat 4 ensuring proper and ample legroom for the passenger seated behind said vehicle seat 4.

The inner trash bag 3 is releasably connected to the outer permanent bag by means of preferably snap buttons 9 or any other simple means to make use of ordinary plastic or paper bags that are readily available for such use. In another embodiment, attachments 10 can be used to releasably connect the outer permanent bag to the inner trash bag 3. The attachments 10 can be for example hooks that penetrate the inner disposable trash bag 3 allowing the hooks to hold the inner trash bag 3 in place. The inner disposable trash bag 3 can be a commercially available trash bag. Alternatively, the inner disposable trash bag can be a reusable/washable or recyclable custom fitting inner bag.

In a preferred embodiment, the vehicle trash disposal system 1 typically operates as follows: a user opens the outer permanent bag 2 by pulling the opening tab 8 and drops a piece of trash inside the inner trash bag 3. The user then closes the bag tightly by pushing gently on the front part 2 of the outer permanent bag against the opposing wall. The closing effort is reduced to a minimum due to the magnetic attraction between the magnetic strips 7. Once the inner trash bag 3 is full, the user detaches the inner disposable trash bag 3 by temporarily removing the snap buttons 9 or the plastic attachments 10 and inserts an empty inner trash bag 3.

While the operation for using the system is simple and accessible to any occupant of the vehicle where said system is installed, it is the objective of the present invention to provide a quick, effortless and safe use for a driver while preventing any significant distraction.

The various embodiments disclosed within this application are all directed towards providing a safe experience to a driver, but also offer the convenience of use for any occupant in the vehicle where the system is installed. Although similar embodiments may be conceived for providing the same quick, effortless and safe use of a trash disposal system in a vehicle, the embodiment disclosed herein are not limiting, rather define specific designs or structures for performing specific functions leading to the disclosed indispensable criteria of rapidity, simplicity and above all, safety.

The vehicle trash disposal system 1 disclosed in the present application is simple in its construction, ergonomic in its use, effective in tightly closing off and hiding trash, minimizing odors and makes use of widely available disposable or recyclable bags thus making it very economical. Furthermore, the system disclosed is designed to be leak-proof, up to the point where any liquid reaches the level of the magnetic strips. These latter function to close the system tightly, however, do not necessarily provide for the sealing of the system and this is not the intention of the present invention.

Although the above description contains many specificities, these should not be construed as limitations on the scope of the invention but is merely representative of the presently preferred embodiments of this invention. The embodiment(s) of the invention described above is(are) intended to be exemplary only. The scope of the invention is therefore intended to be limited solely by the scope of the appended claims.

What is claimed:

1. A safe trash disposal system for use in vehicles, comprising:
An outer permanent bag consisting of a back part, a front part and two side parts, wherein the front part of said outer permanent bag comprises a frame, magnetic strips, a tab;
A top adjustable connection;
A bottom adjustable connection; and
An inner trash bag releasably connected to the outer permanent bag.

2. The system of claim 1, wherein the frame consists of two longitudinal rods extending from the bottom to the top of the front part of the outer permanent bag.

3. The system of claim 1, wherein the frame consists of a rectangular-shaped hard frame which extends around the perimeter of the front part of the outer permanent bag.

4. The system of claim 1, wherein the frame consists of a U-shaped hard frame which extends around three sides of the front part of the outer permanent bag.

5. The system of claim 1, wherein the frame provides rigidity to the front part of the outer permanent bag and prevents it from folding or bending.

6. The system of claim 1, wherein the top of the back and front parts enclose a magnetic strip each, wherein said magnetic strips are in full parallel alignment.

7. The system of claim 1, wherein the tab is located towards the top of the front part of the outer permanent bag, and preferably at the same level of the magnetic strip embedded in the front part.

8. The system of claim 1, wherein the top adjustable connection tightly secures the outer permanent bag to the top of a vehicle seat, and preferably around the head rest of said seat.

9. The system of claim 1, wherein the bottom adjustable connection tightly secures the outer permanent bag to the bottom of a vehicle seat.

10. The system of claim 1, wherein the top and bottom adjustable connections securely hold the outer permanent bag in an immovable position, until released.

11. The system of claim 1, wherein the two sides extend from the bottom where the front and back parts of outer permanent bag meet to the top of each of the front and back parts.

12. The system of claim 1, wherein the upper parts of the sides of the outer permanent bag form a downward pointing shape from the top of each of the front and back parts, and wherein once closed, folded material from the sides does not form between the magnetic strips.

13. The system of claim 1, wherein combined, the elements comprising the frame and the shape and design of the sides maintain the front part of the permanent outer bag in a rigid, flat and accurate position, permanently ensuring the proper alignment of the opposing magnetic strips.

14. Use of the system of claim 1 in a vehicle, wherein said use:
maintains proper legroom in the vehicle;
minimizes bad odors in the vehicle;
is leak-proof up to the level where the magnets close the system;
is ergonomic;
is quick and effortless; and
is safely accessible by the driver of the vehicle without any significant distraction.

15. A method for using the system of claim 1, wherein said method consists of the following steps:
step 1: quickly and effortlessly pull on the tab to open the system without the need to be looking at the system;
step 2: efficiently place waste or trash into the open system without the need to be looking at the system;
step 3: quickly and effortlessly push on the top of the front part to bring the magnets closer together to tightly close the system, without the need to be looking at the system.
